(19) United States
(12) Patent Application Publication
(10) Pub. No.: US 2025/0359562 A1
(43) Pub. Date: Nov. 27, 2025

(54) BONE-IN BEEF SLICING SYSTEM

(71) Applicant: Ross Industries, Inc., Midland, VA (US)

(72) Inventors: Lonnie Jamie Usrey, JR., Midland, VA (US); William Lee Harrison, Midland, VA (US)

(73) Assignee: Ross Industries, Inc., Midland, VA (US)

(21) Appl. No.: 19/216,812

(22) Filed: May 23, 2025

Related U.S. Application Data
(60) Provisional application No. 63/651,126, filed on May 23, 2024.

(51) Int. Cl. A22C 17/00

(52) U.S. Cl. CPC A22C 17/0033; A22C 17/0093

(57) ABSTRACT

A meat product guidance and slicing system including a chute to slide meat products toward a slicing system and upper and lower meat product supports to apply pressure to the meat product that is sliding through the chute to prevent the meat product from rotating while being slid toward the slicing system. The meat product guidance and slicing system also includes an adjustable means to adjust the thickness of a piece of the meat product to be sliced therefrom.

### STATEMENT REGARDING FEDERALLY SPONSORED RESEARCH OR DEVELOPMENT

Not applicable.

### BACKGROUND OF THE INVENTIVE CONCEPT

### 1. Field of the Invention

The present inventive concept relates to a bone-in beef slicing system. More particularly, but not exclusively, this inventive concept relates to a bone-in beef slicing system that can prevent rotation of meat products being fed through a chute towards a slicing blade and can automatically adjust a thickness of slices of meat being sliced from meat products being fed to the slicing blade.

### Description of the Related Art

Industrial meat slicing systems are well known in the art of food processing. However, when large slabs of bone-in-beef or other types of bone-in meat products are being mechanically fed through a slicer the sliced pieces of meat can result in being jagged, shredded or unsightly for display on a shelf of a produce market. This can be caused by the cutting blade cutting the meat before the bone, thus chewing up, ripping or shredding the meat before the blade reaches the bone. In addition, when different thicknesses of slices of meat, such as steaks, are desired to be cut from a large bone-in meat product it can be cumbersome to stop the meat from being sliced, adjust the blade positioning to obtain a predetermined thickness of a slice of meat or steak and then restart the cutting machine.

Accordingly, there is a need for a bone-in meat product feeding system that will ensure that as the bone-in meat product is being fed to the slicing blade the bone-in meat product remains in a desired position such that the bone always gets sliced by the blade before the meat portion is sliced, thus resulting in a slice of meat or steak with smooth outer surfaces.

There is also a need for a bone-in meat product slicing system that can automatically be adjusted while being operated to quickly adjust a thickness of a slice of meat or steak to be sliced off the bone-in mean product.

### SUMMARY OF THE INVENTIVE CONCEPT

The present general inventive concept provides a bone-in beef slicing system that can automatically adjust to secure in place any size and shape slab of beef as the slab of beef is being sliced into individual pieces.

The present general inventive concept also provides a bone-in beef slicing system that can adjust a blade speed and a cutter speed of a rotating blade to provide smooth sliced surfaces for individual pieces of a bone-in beef.

The present general inventive concept also provides a bone-in beef slicing system that eliminates bone dust (i.e., fine bone particles created during the cutting process) adhesion while slicing a slab of bone-in beef into individual pieces.

The present general inventive concept also provides a bone-in beef slicing system that can automatically cut different thicknesses of slices of product such that every individual slice can have a different thickness, or different sections of a product can be cut to suit the type of product.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a meat slicing system to slice bone-in meat products, the system comprising: a frame; an elongated hollow chute connected to and extending upward from the frame to receive meat products therein, the chute including a follower configured to slide along an internal portion of the hollow chute by force of gravity to apply a force against the meat products therein to slide the meat product along the hollow chute; an upper meat product support extending perpendicular to the chute, the upper meat product support including a first roller system extending therefrom and at least one pressure operated arm configured to apply pressure to the upper meat product support and the first roller system to press the first roller system against the meat product disposed within the chute to prevent the meat product from rotating as the meat product slides along the chute; a lower meat product support disposed directly below the upper meat product support, the lower meat product support extending perpendicular to the chute and including a second roller system extending therefrom and at least one pressure operated arm configured to apply pressure to the lower meat product support and the second roller system to press the second roller system against the meat product disposed within the chute to prevent the meat product from rotating as the meat product slides along the chute; a circular plate including a solid section and a cutout section, the circular plate including a first rotational shaft extending through a center thereof to rotate the circular plate such that the circular plate receives the meat product thereon and stops the meat product from sliding through the chute when the solid section thereof is rotated to a position adjacent to the chute; and a transmission housing configured to rotate about the first rotating shaft and including a second rotational shaft that extends therefrom and is adjacent to the first rotational shaft of the circular plate, the second rotational shaft being connected to a center of a circular blade such that the circular blade is disposed between the chute and the circular plate, the circular blade being configured to rotate about a first rotation axis with the second rotational shaft and to rotate about a second rotation axis together with the first rotational shaft and the transmission housing such that the circular blade rotates towards meat product to slice off a predetermined thickness of the meat product when the solid section of the circular plate is in contact with the meat product.

In an exemplary embodiment the first roller system can be connected to the upper meat product support by a first hinge connector such that the first roller system pivots to accommodate meat products with different shapes; and the second roller system can be connected to the upper meat product support by a second hinge connector such that the second roller system pivots to accommodate meat products with different shapes.

In another exemplary embodiment the first roller system can include a roller shaft with at least two rollers rotatably disposed thereon to roll along the meat product when the meat product slides along the hollow chute; and the second roller system can include a roller shaft with at least two rollers rotatably disposed thereon to roll along the meat product when the meat product slides along the hollow chute.

In another exemplary embodiment the at least one pressure operated arm of the upper meat product support can include a first pair of pressure operated arms, each first pressure operated arm being movable with respect to the upper meat product support; and the at least one pressure operated arm of the lower meat product support can include a pair of pressure operated arms, each pressure operated arm being movable with respect to the lower meat product support.

In still another exemplary embodiment the meat slicing system can further include: a first support table connected to the hollow chute and including a pair of first support table posts connected thereto, each one of the pair of first pressure operated arms extending through a respective one of the first support table posts; and a second support table connected to the hollow chute below the first support table and including a pair of second support table posts connected thereto, each one of the pair of second pressure operated arms extending through a respective one of the second support table posts.

In still another exemplary embodiment the pair of pressure operated arms of the upper and lower meat product supports can be pneumatic or hydraulic pressure operated arms.

In still another exemplary embodiment the meat slicing system can further include: at least one follower rod extending along an outer side of the hollow chute and in parallel with the hollow chute, the at least one follower rod being engaged with an outer side of the follower to enable the follower to slide along the follower rod and along the internal portion of the hollow chute.

In still another exemplary embodiment the at least one follower rod can include a first follower rod disposed along a first side of the hollow chute and a second follower rod disposed at a second side of the hollow chute opposite the first side, both follower rods being engaged with the follower to enable the follower to slide along the first and second follower rods and along the internal portion of the hollow chute.

In still another exemplary embodiment the meat slicing system can further include: a first drive rotational system connected to the frame and configured to rotate the first rotational shaft.

In still another exemplary embodiment the meat slicing system can further include: a lift motor attached to the first rotational shaft to raise and lower a height of the circular plate such that different thicknesses of slices of meat product can be sliced off from the meat product extending out of the chute.

In still another exemplary embodiment the first roller system and the second roller system can each include four rollers adjacent to each other to roll along the meat product as the meat product slides through the chute.

The foregoing and/or other features and utilities of the present general inventive concept may be achieved by providing a meat slicing system to slice bone-in meat products, the system comprising: a frame with a surface thereon, the surface including a hole therethrough; an elongated hollow chute connected to and extending upward from the hole in the surface of the frame to receive meat products therein and feed the meat products through the hole; a pair of follower rods extending in parallel along opposite sides so the chute, the pair of follower rods including a follower slidably attached to each of the pair of follower rods and configured to slide along the inner portion of the chute to force meat products to slide within the chute and through the hole in the surface of the frame; a first support table surrounding the chute such that the chute extends therethrough, the first support table including a pair of first support table posts connected thereto, each of the pair of first support table posts including a respective one of a pair of first pressure operated arms movably extending therethrough; a first roller system connected to the first pair of pressure operated arms to apply pressure to the meat product disposed within the chute to prevent rotation of the meat product while sliding through the chute; a second support table surrounding the chute and disposed directly below the first support table such that the chute extends therethrough, the second support table including a pair of second support table posts connected thereto, each of the pair of second support table posts including a respective one of a pair of second pressure operated arms movably extending therethrough; a second roller system connected to the second pair of pressure operated arms to apply pressure to the meat product disposed within the chute to prevent rotation of the meat product while sliding through the chute; a first rotational drive system connected to the frame below the surface thereof and including a first rotational shaft extending therefrom; a circular plate including a solid portion and a cutout portion, the circular plate being connected at a center thereof to the first rotational shaft to rotate the circular plate; a transmission housing connected to the first rotational shaft to rotate with the first rotational shaft and including a second rotational shaft extending from a center thereof and disposed adjacent to the first rotational shaft; and a circular blade connect to the second rotational shaft at a center portion thereof and disposed between the chute and the circular plate, the circular blade being configured to rotate about a second rotation axis with the second rotational shaft and to rotate about a first rotation axis with the first rotational shaft and the transmission housing such that the circular blade rotates towards meat product extending out of the chute to slice off a predetermined thickness of the meat product when the solid section of the circular plate is in contact with the meat product.

In an exemplary embodiment the meat slicing system can further include: a lift motor attached to the first rotational shaft to raise and lower a height of the circular plate such that different thicknesses of slices of meat product can be sliced from the meat product extending out of the chute.

The foregoing and/or other features and utilities of the present general inventive concept may be achieved by providing a meat product feeding system to feed meat products to a meat slicer, the system comprising: a frame including a surface with an opening therethrough; an elongated hollow chute connected to and extending upward from the surface of the frame above the opening to receive meat products therein; a follower configured to slide along the inside of the chute to slide the meat products through the chute; a first support table connected to and surrounding the chute and above the frame surface, the first support table including a pair of first support table posts connected thereto; a first roller system connected to a first pair of pressure operated arms to apply pressure to the meat product disposed within the chute, the first pair of pressure operated arms extending through the first pair of support table posts and configured to extend therethrough to move the first roller system against the meat products to prevent the meat products from rotating within the chute while the meat products are slid through the chute; a second support table connected to and surrounding the chute and disposed below the first support table, the second support table including a pair of second support table posts connected thereto; and a second roller system connected to the second pair of pressure operated arms to apply pressure to the meat product disposed within the chute, the second pair of pressure operated arms extending through the pair of second support table posts and configured to extend therethrough to move the second roller system against the meat products to prevent the meat products from rotating within the chute while the meat products are slid through the chute.

In an exemplary embodiment the meat product feeding system can further include: a pair of follower rods extending in parallel along opposite sides of the chute, the pair of follower rods being slidingly connected to the follower to guide the follower to slide along the inside of the chute to slide the meat products through the chute.

### BRIEF DESCRIPTION OF THE DRAWINGS

These and/or other features and utilities of the present inventive concept will become apparent and more readily appreciated from the following description of the embodiments, taken in conjunction with the accompanying drawings of which:

FIG. 1 illustrates a side view of a bone-in beef slicing system according to an example embodiment of the present inventive concept;

FIG. 2 illustrates a top perspective view of the bone-in beef slicing system according to example embodiment of FIG. 1;

FIG. 3 illustrates a top perspective view of a bone-in meat guiding system of the bone-in beef slicing system according to example embodiment of FIG. 1;

FIG. 4 illustrates another top perspective view of the bone-in meat guiding system of the bone-in beef slicing system according to example embodiment of FIG. 1;

FIG. 5 illustrates a side view of the bone-in meat guiding system of the bone-in beef slicing system according to example embodiment of FIG. 1;

FIG. 6 illustrates a top view of the bone-in meat guiding system of the bone-in beef slicing system according to example embodiment of FIG. 1;

FIG. 7 illustrates another top view of the bone-in meat guiding system of the bone-in beef slicing system according to example embodiment of FIG. 1;

FIG. 8 illustrates a rear view of the bone-in meat guiding system of the bone-in beef slicing system according to example embodiment of FIG. 1;

FIG. 9 illustrates a front view of the bone-in meat guiding system of the bone-in beef slicing system according to example embodiment of FIG. 1;

FIG. 10 illustrates atop perspective view of a slicing and conveying system of the bone-in beef slicing system according to example embodiment of FIG. 1;

FIG. 11 illustrates a side view of a blade/cutter and transmission system of a bone-in beef slicing system, according to an example embodiment of the present inventive concept;

FIG. 12 illustrates another side view of a blade/cutter and transmission system of a bone-in beef slicing system, according to an example embodiment of the present inventive concept;

FIG. 13 illustrates an internal view of the blade/cutter and transmission system according to the example embodiment of FIGS. 11 and 12; and

FIG. 14 illustrates a detailed view of the rotational motors for a blade and rotating table of the bone-in beef slicing system according to an example embodiment.

The drawings illustrate a few example embodiments of the present inventive concept and are not to be considered limiting in its scope, as the overall inventive concept may admit to other equally effective embodiments. The elements and features shown in the drawings are to scale and attempt to clearly illustrate the principles of exemplary embodiments of the present inventive concept. In the drawings, reference numerals designate like or corresponding, but not necessarily identical, elements throughout the several views.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures. Also, while describing the present general inventive concept, detailed descriptions about related well-known functions or configurations that may diminish the clarity of the points of the present general inventive concept are omitted.

It will be understood that although the terms “first” and “second” are used herein to describe various elements, these elements should not be limited by these terms. These terms are only used to distinguish one element from another element. Thus, a first element could be termed a second element, and similarly, a second element may be termed a first element without departing from the teachings of this disclosure.

Expressions such as “at least one of,” when preceding a list of elements, modify the entire list of elements and do not modify the individual elements of the list.

All terms including descriptive or technical terms which are used herein should be construed as having meanings that are obvious to one of ordinary skill in the art. However, the terms may have different meanings according to an intention of one of ordinary skill in the art, case precedents, or the appearance of new technologies. Also, some terms may be arbitrarily selected by the applicant, and in this case, the meaning of the selected terms will be described in detail in the detailed description of the invention. Thus, the terms used herein have to be defined based on the meaning of the terms together with the description throughout the specification.

Also, when a part “includes” or “comprises” an element, unless there is a particular description contrary thereto, the part can further include other elements, not excluding the other elements. In the following description, terms such as “unit” and “module” indicate a unit to process at least one function or operation, wherein the unit and the block may be embodied as hardware or software or embodied by combining hardware and software.

Hereinafter, one or more exemplary embodiments of the present general inventive concept will be described in detail with reference to accompanying drawings.

Example embodiments of the present general inventive concept are directed to bone-in beef slicing system configured to automatically adjust product (i.e., a large slab of bone-in beef) as the product is being sliced into individual pieces.

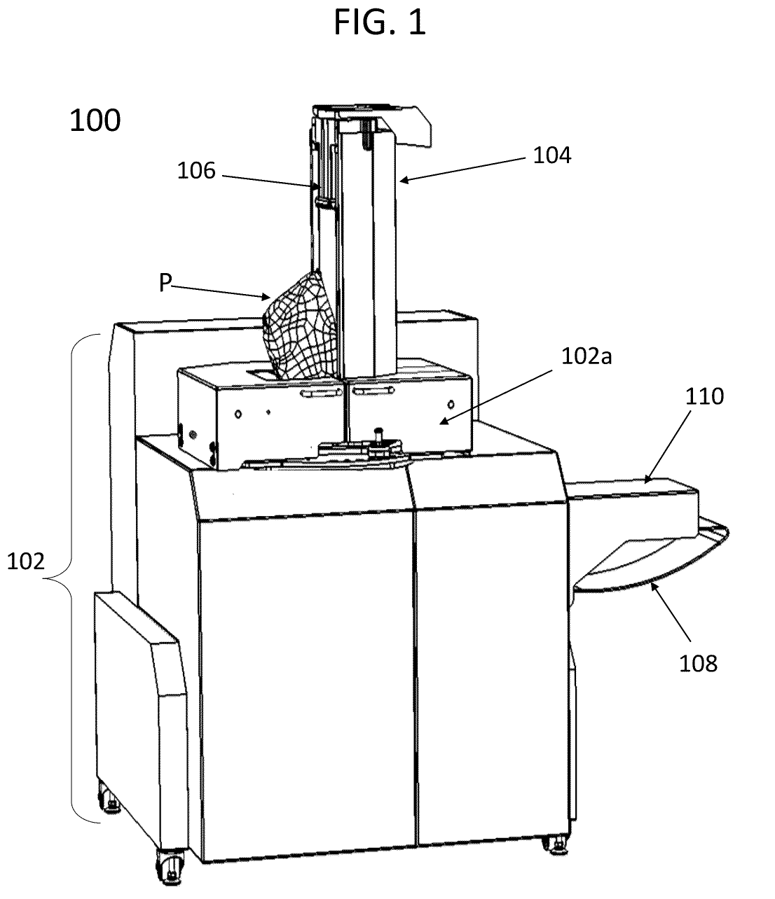

Referring to FIG. 1, a bone-in beef slicing system 100 is illustrated. This bone-in beef slicing system 100 can include a cabinet 102 and a chute 104 which preferably extends vertically upward out of the cabinet 102 to receive product P therein and to receive the maximum product yield. However, the chute 104 can alternatively be disposed at an angle which will accommodate product P to be received therein. The chute 104 can be configured to have a back section and two sides such that a product P can be placed within the two sides and back section to hold the product P in place while being sliced into individual pieces and sliding downward along the chute 104. More specifically, as the product P is being sliced into individual pieces, each individual piece will be detached from and fall off the slab of product P onto a discharge conveyer 108 to be conveyed out of the bone-in beef slicing system 100. Alternatively, the chute 104 can include only two sides, thus resulting in a wedge shape. The product P moves downward along the chute 104 as the product P is being sliced with the aid of a follower 106. The follower 106 can be configured to slide along an inside portion of the chute 104 such that the follower 106 presses down on the product P as the product P is being sliced, thus guiding the product P to continue to move down along the chute 104 while being sliced. The follower 106 is also configured to provide stability to the product P while being sliced by preventing the product P from leaning out of the chute 104. The follower 106 is also configured to prevent the product P from rotating within the chute 104 while being sliced. In addition, the follower 106 enables obtaining square cuts of the product P, not trapezoid cuts.

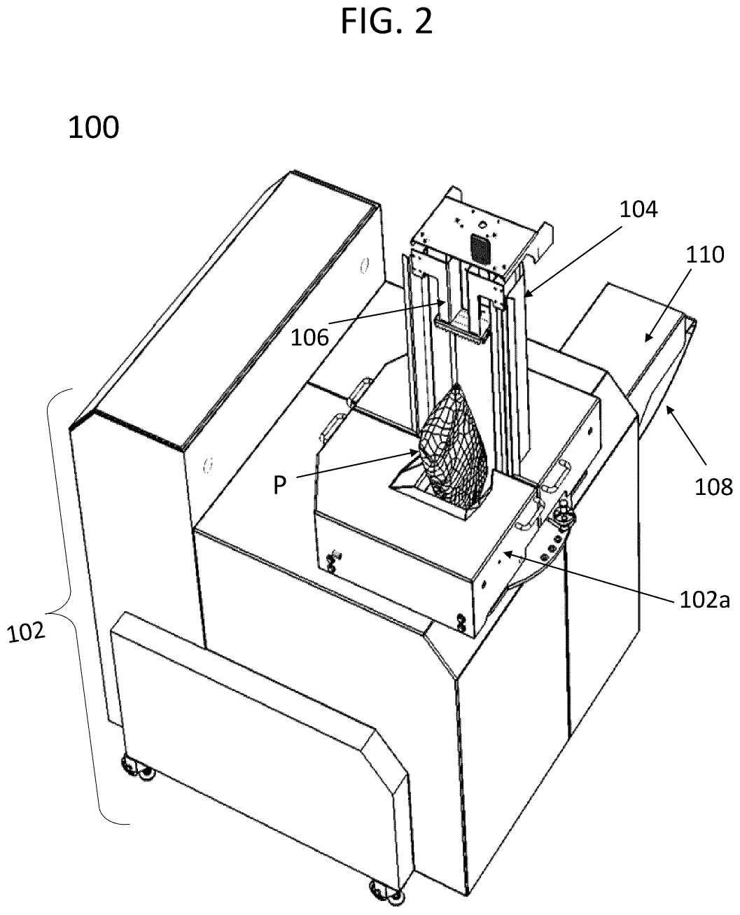

Referring to FIG. 2, the product P can be placed within the chute 104 while the follower 106 is at a position high enough within the chute 104 such that new product can enter the chute 104 while loading the chute 104. Then the follower 106 is slid down the chute 104 until the follower 106 presses downward on the product P due to force of gravity on the follower 106. The follower 106 can be driven along the chute 104 pneumatically or mechanically by a motor. However, the follower 106 can be driven by any controller device which will result in a sufficient controlled force being applied to the product P while preventing tipping or rotating of the product P while being fed down the chute 104 during slicing.

The product P is held in place by a product support system (described in more detail below) which is preferably disposed within an upper cabinet portion 102a. As the product P is sliced, the individual slices will fall onto the discharge conveyer 108 to be fed outward of the system 100. A conveyer cover 110 can be provided to prevent any bone dust and/or liquid from spraying out of the system 100 while the product P is being sliced into individual pieces (i.e., slabs of beef).

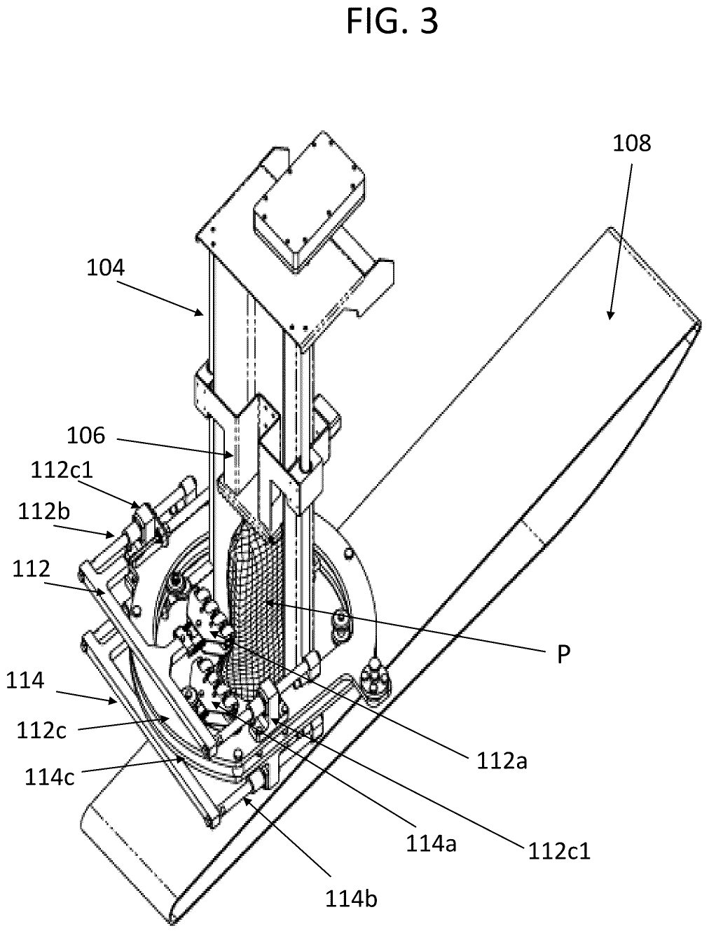

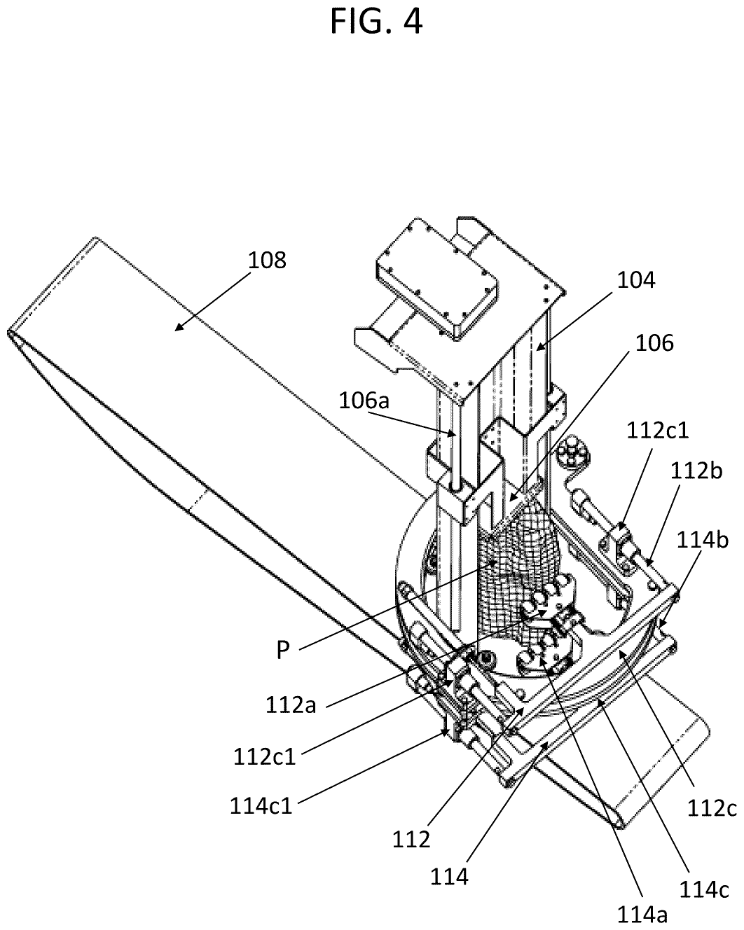

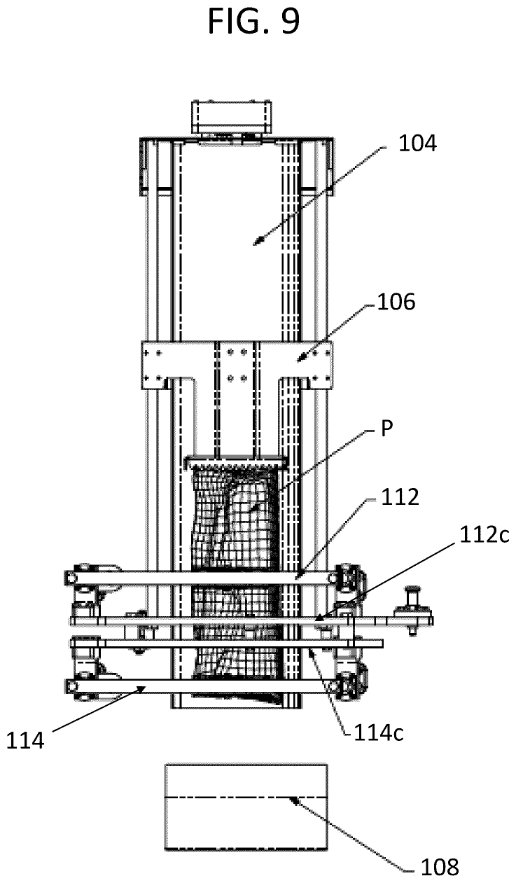

Referring to FIGS. 3 and 4, a product support system can include an upper product support 112 and a lower product support 114. Both the upper product support 112 and the lower product support 114 can be identical and operate the same. Accordingly, the description of the features of the upper product support 112 will similarly apply to the lower product support 114. The upper product support 112 extends horizontally and can include a roller system 112a extending from a middle of the upper product support 112. The roller system 112a can include at least one roller 112a1 which is configured to press against the product P to keep the product P within the chute 104. More specifically, the roller system 112a is configured to hold the product P from moving within the chute 104 such that the bone within the product P remains in a position such that a rotating blade 122 (see FIG. 9) always slices the bone of the product P before the meat of the product P whenever possible.

The upper product support 112 can also include a pair of pneumatic (or hydraulic or electric) operated arms 112b, one pneumatic arm 112b extending from each of opposite ends of the upper support 112. The pneumatic arms 112b can provide a continuous pressure inward such that the roller system 112a holds the product P in place within the chute 104. The pneumatic arms 112b act independently with respect to one another such that positioning of the upper product support 112 can automatically adjust depending on the shape and size of the product P. With the configuration of the upper support 112, including the pneumatic arms 112b and roller system 112a, all shapes and sizes of bone-in products P can be held in place within the chute 104 while being sliced into individual pieces/slabs, and then be fed out of the bone-in beef slicing machine 100 via the discharge conveyer 108. The product supports 112 and 114 can be controlled by a motor system.

The upper product support 112 can be held in position with a corresponding support table 112c, while the pneumatic arms 112b can pivot back and forth within corresponding support table posts 112c1. The support table 112c is preferably configured in a circular shape such that the chute 104 can extend through a middle section thereof while the support table 112c remains stably attached to a surface of the cabinet 102.

FIG. 4 illustrates the lower support 114 including a roller system 114a, a pair of pneumatic (or hydraulic or electric) operated arms 114b, a support table 114c and corresponding support table posts 114c1. Similar to the support table 112c, the support table 114c is preferably configured in a circular shape such that the chute 104 can extend through a middle section thereof while the support table 114c remains stably attached to a surface of the cabinet 102. The circular mounted support tables 112c and 114c provide a universal design to allow for supporting forces on a vector which best squares the product P within the chute 104.

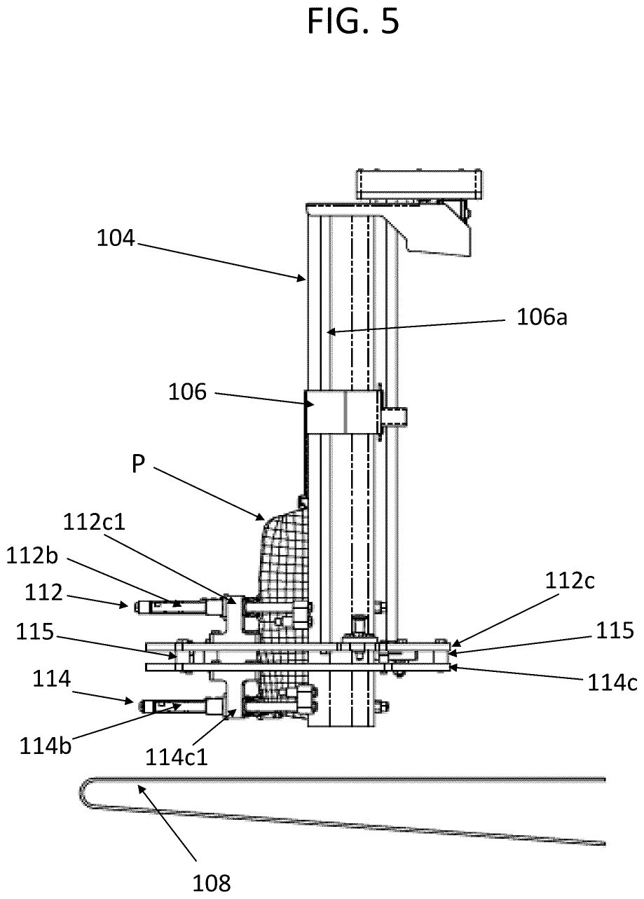

Referring to FIG. 5, the support table 112c and the support table 114c can be attached to each other by at least one table attachment unit 115 so that the support tables 112c and 114c remain in a stable position surrounding the chute 104.

The upper support 112 and lower support 114 can be either mounted to the cabinet 102 or to the chute 104. The arms 112b and 114b can be operated by other equivalent driving devices which will provide the intended purposes of best squaring the product P within the chute 104.

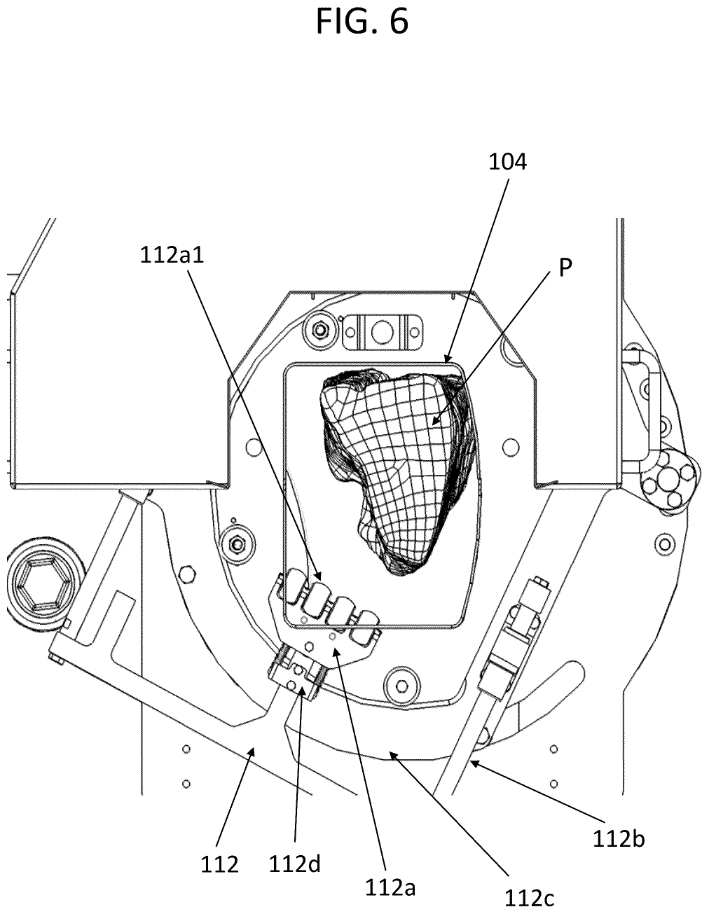

Referring to FIG. 6, the roller system 112a of the upper product support 112 can include a set of aligned rollers 112a1 disposed along a common axle. These rollers 112a1 are configured to roll along the surface of the product P as the product P slides down the chute 104 while being sliced. The roller system 112a can also be configured to be attached to the upper product support 112 by way of a hinge type connector 112d such that products P of different shapes can be accommodated and held in place by the upper product support 112. As different shapes of product P are placed within the chute 104, the roller system 112a (114a) and corresponding rollers 112a1 (114a1) can pivot on the hinge type connector 112d (114d) to rest at a secure position against the product P.

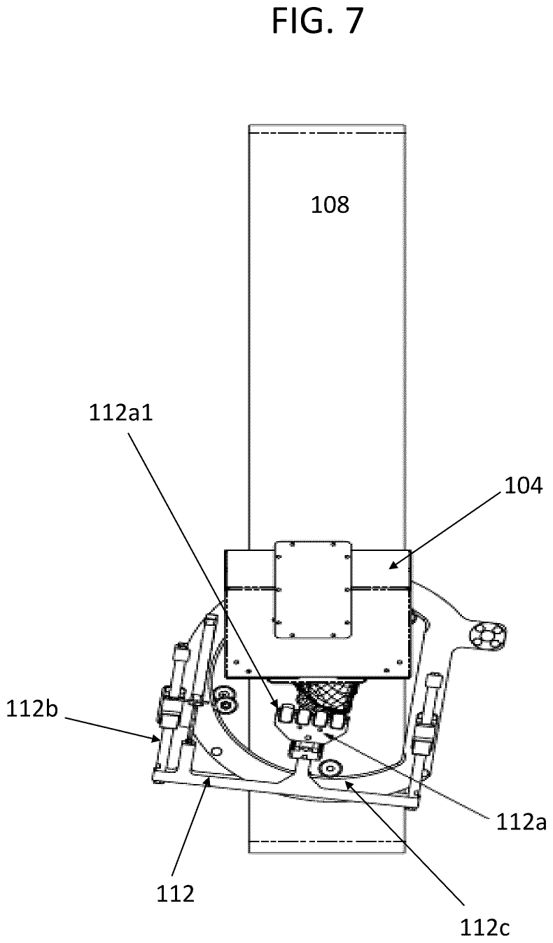

FIG. 7 illustrates a positioning of the roller system 112a and corresponding rollers 112a1 positioned to rest against a bone of a product P disposed within the chute 104. The roller system 114a and corresponding rollers 114a1 are directly below the roller system 112a and corresponding rollers 112a1 and perform the same operations. The roller systems 112a and 114a are configured to ensure that the product P remains in a position such that the bone of the product P remains in place so that the blade 122 slices the bone portion of the product P before the meat portion of the product P. With this configuration the product P will be sliced into individual pieces while the product P remains in place, and such that outer surfaces of each piece are sliced smoothly, thus avoiding any pitting of the surfaces of the individually sliced pieces of product P. Although the roller systems 112a and 114a can be positioned to push against the flesh of the product P, for purposes of obtaining the best cuts, it is preferable that the product P is positioned such that the cutting blade (described in more detail below) cuts the bone first to avoid displacement of the flesh, which results in a cut that can be tapered, wavy and include craters. The smoothness of the outer surfaces of the individual slices are further obtained by a specific rotation speed and specific cutting speed of a rotational blade 122, which will be described in more detail below.

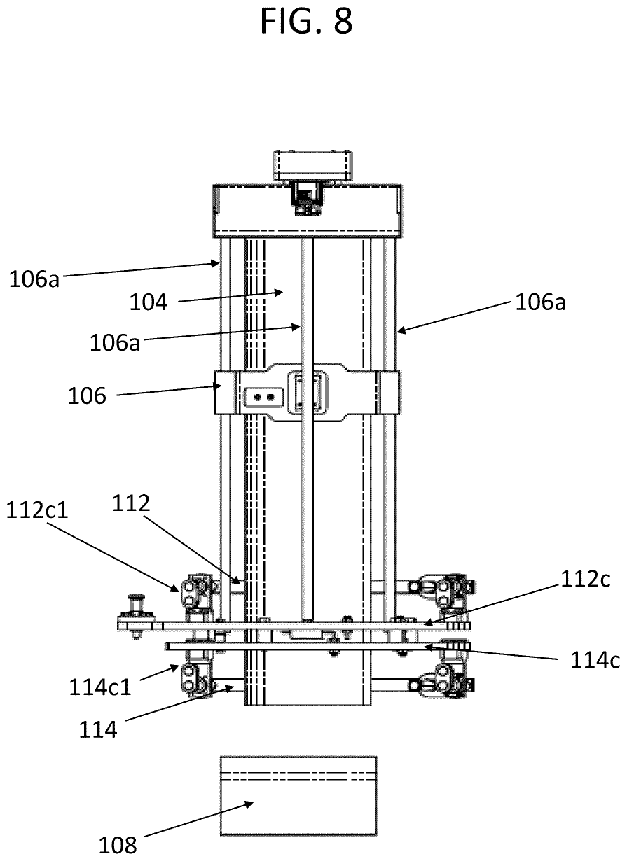

FIG. 8 illustrates a rear view of the chute 104, the follower 106, product support system 112, 114, and discharge conveyer 108, according to an example embodiment of the present inventive concept. As illustrated in FIG. 8, the follower 106 can be aligned to slide along the chute 104 with the aid of at least one follower rod 106a. The at least one follower rod 106a is preferably disposed in parallel with and along an outside of the chute 104 to allow the follower 106 to slide along the outer surfaces of the chute 104 while a front part of the follower 106 extends into the chute 104 (see FIGS. 4, 5 and 8).

FIG. 9 illustrates a front view of the chute 104, follower 106, product support system 112, 114, and discharge conveyer 108, according to an example embodiment of the present inventive concept. As illustrated, the upper product support 112 and the lower product support 114 face directly toward the product P as the product P is placed within the chute 104. The follower 106 is slid down along the follower rods 106a until the follower 106 makes contact with the product P, at which point the follower 106 will continue to apply a controlled force on the product P to ensure that the product P is continuously fed past the rotational blade 122 for slicing into individual pieces.

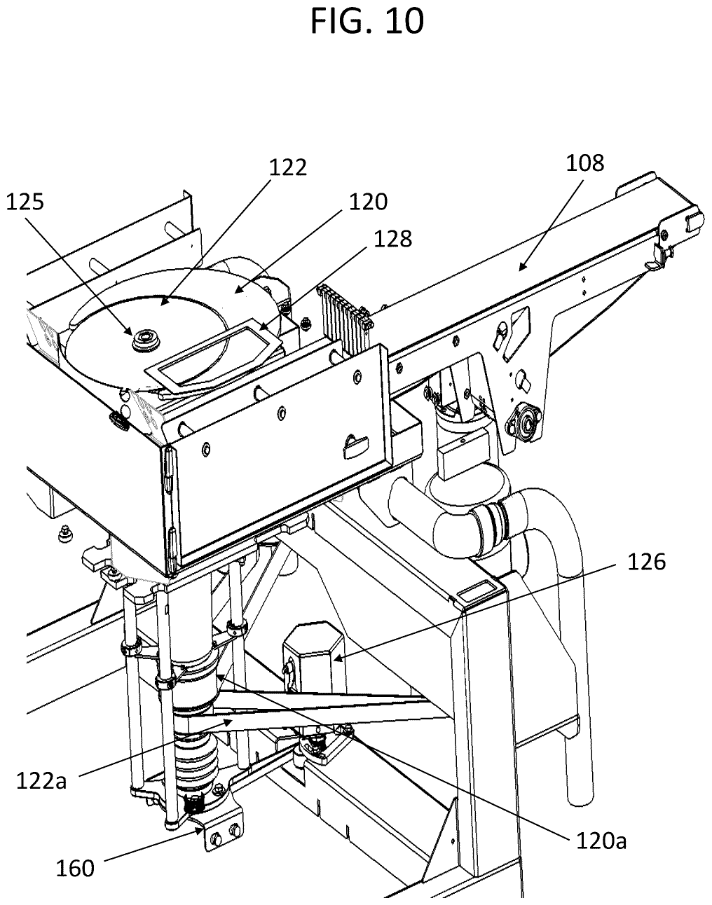

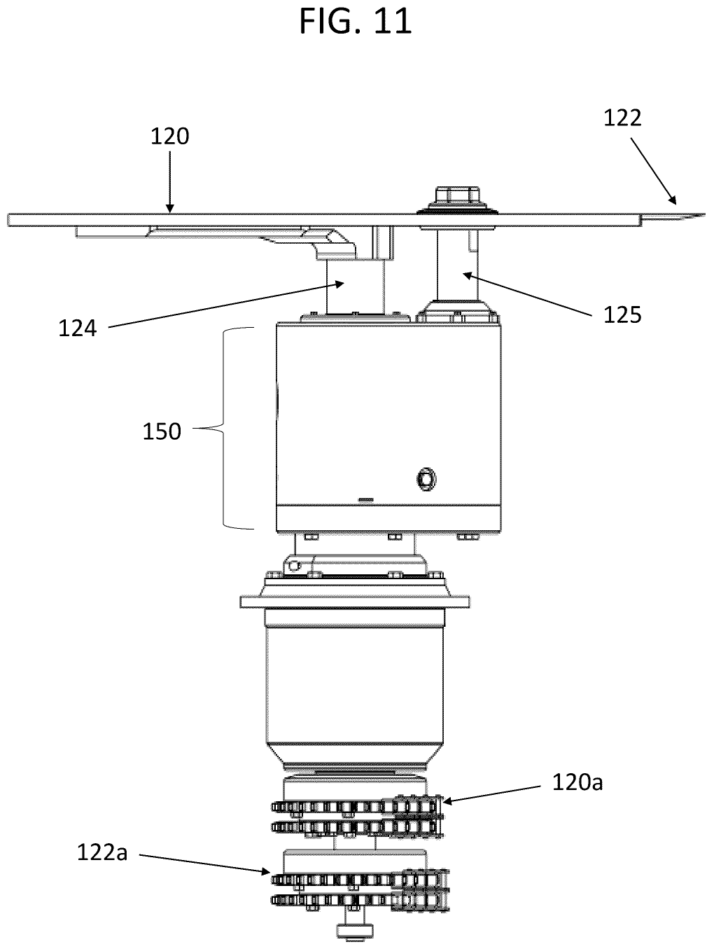

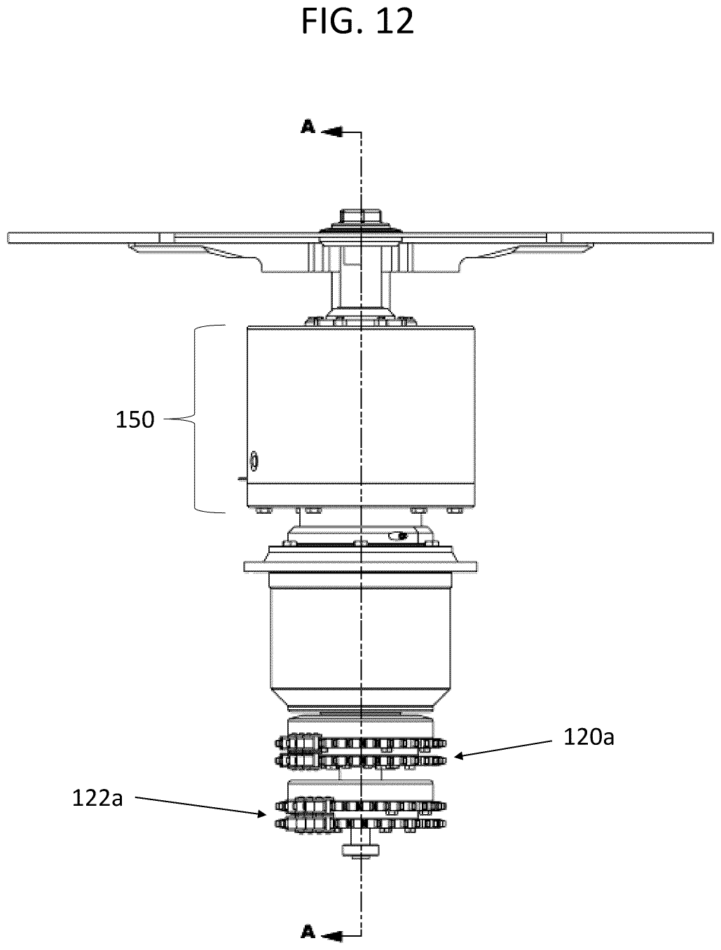

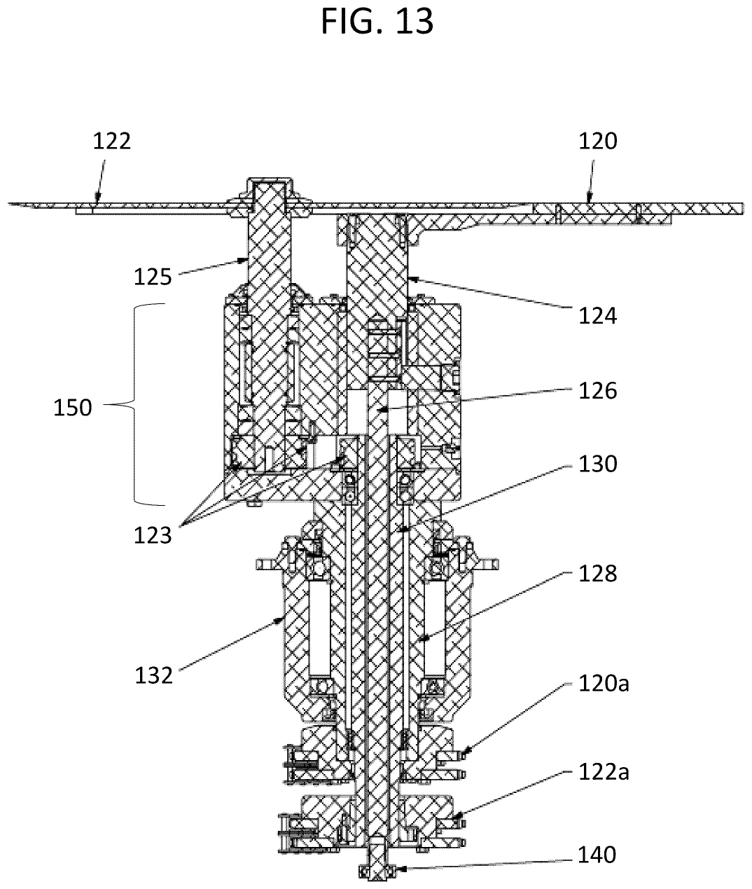

FIG. 10 illustrates a plan view of a blade/cutter and transmission system of the bone-in beef slicing system, according to an example embodiment of the present inventive concept. FIG. 11 illustrates a side view of the blade/cutter and transmission system. FIG. 12 illustrates another side view of the blade/cutter and transmission system. The blade and cutter transmission system components according to this example embodiment can include a rotating plate 120 configured to rotate under the product P while the product P is disposed in the chute 104 and being fed toward the plate 120 by the follower 106. The plate 120 also acts as a thickness table, which will be described in more detail below with respect to FIG. 13. A circular rotating blade 122 is stationary with respect to height, and therefore the blade 122 can be disposed adjacent to or above the rotating plate 120 by movement of the rotating plate 120, which is described in more detail below.

The rotating plate 120 and the rotating blade 122 can be disposed on a same axis of rotation via a thickness table shaft 124 (see FIGS. 11, 12 and 13). The plate 120 is preferably offset from its center with respect to the thickness table shaft 124 such that pieces of the sliced product P can fall past the plate 120 at the exact time that each piece of the product P is fully sliced away from the product P itself by the blade 122. In other words, the plate 120 can be configured to rotate away from underneath the product P at the same time that an individual slice of the product P is completely sliced off such that the individually sliced piece of product P falls past the plate 120 and onto the discharge conveyer 108.

The blade 122 and blade shaft 125 are configured to rotate about the thickness table shaft 124 via an upper transmission housing 150. Accordingly, the blade 122 is configured to rotate on the blade shaft 125 separately from the plate 120 while both the plate 120 and the blade 122 are being rotated about the thickness table shaft 124. More specifically, while the blade 122 rotates at one rotational speed on a blade shaft 125, the blade 122 also rotates around the thickness table shaft 124 while the plate 120 rotates on the thickness table shaft 124. As a result, the blade 122 will continually rotate on the blade shaft 125 while swinging toward and away from the product P about the thickness table shaft 124. One full rotation of the blade 122 about the thickness table shaft 124 results in a new fully sliced piece of the product P.

Referring to FIG. 11 through FIG. 13, the plate 120 is rotated about the thickness table shaft 124 by a cutter drive rotational system (or cutter drive pulley system) 120a while the blade 122 is driven to rotate on a blade shaft 125 by a second separate blade drive rotational system (or blade drive pulley system) 122a.

FIG. 13 illustrates a sectional view of the blade/cutter and transmission system according to the example embodiment of FIG. 10. Referring to FIG. 13, a cutter spindle 128 can be configured to extend upward from the first rotational system 120a to rotate the blade 122 (and blade shaft 125) eccentrically around the thickness table shaft 124 while rotating the plate 120 on the thickness table shaft 124. The rotational speed of the cutter spindle 128 is referred to as a cutter rotation speed. The cutter rotation speed is preferably set to substantially 90 revolutions per minute (90 rpms), which has been found through testing by the Applicant to be the most effective cutter speed for the product P cutting process. The cutter rotation speed is referred to as the rotation speed in which the blade 122 rotates into and away from the product P. Each full rotation of the blade 122 about the thickness table shaft 124 produces a sliced piece of the product P. The cutter spindle 128 drives an upper transmission housing 150, which in turn rotates the thickness table shaft 124, with the table 120, and the blade shaft 125, with the blade 122 together at the cutter rotation speed.

A blade drive shaft 130 is configured to spin the blade 122 on the blade shaft 125, and is driven by the blade drive rotational system 122a. The cutter drive rotational system 120a and the blade drive rotational system 122a can be configured to include a motor and belt combination, wherein the belt wraps around a rotational portion of a corresponding motor (not illustrated) as well as pulleys of the corresponding cutter drive rotational system 120a and the blade drive rotational system 122a. The blade drive rotational system 122a can be operated by a servo motor to accurately control the rotational speed of the blade 122.

The rotating blade 122 preferably includes teeth around an outer circumference thereof. The blade 122 preferably includes a tooth profile where the teeth are serrated, smaller and spread wider apart than the teeth of a conventional band blade. With this specific design of the blade 122, fresh product P (such as fresh beef, not frozen beef) is sliced without any fat in the product P being dragged/smeared over the product P as the product P is being sliced. Additionally, the blade 122 will abrade the sliced surfaces of the product P to significantly reduce “Kerf Loss” (i.e., loss of meat during the slicing) and provide clean sliced surfaces of each sliced piece of the product P.

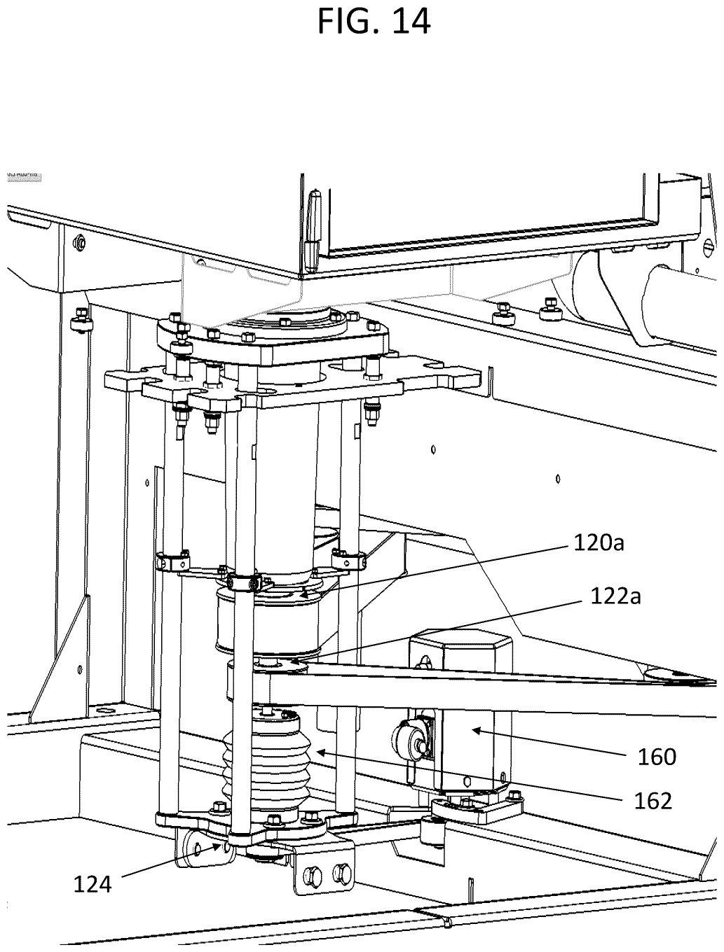

Referring to FIGS. 13 and 14, a lift motor 160 can be attached to an attachment point 140 of a thickness table post 126 to raise and lower the height of the thickness table 120. The thickness table post 126 is connected to a lower end of the thickness table shaft 124, and raises and lowers the thickness table shaft 124 together with the thickness table 120 to control the desired thickness or each slice of the product P. In accordance with an example embodiment, the lift motor 160 can be programmed to change a thickness of each slice of product P differently, if desired, or can control the thickness of the slices of product P depending on the part of the product P being sliced. A thickness mechanism 162 is driven by the lift motor 160 to raise and lower the thickness table post 126 and thickness table shaft 124. The thickness mechanism 162 can include a bellows type system which collapses and expands.

As pointed out above, the cutter speed is preferable set to approximately 90 revolutions per minute (rpms), which after significant testing and experimentation, has been determined to be the best speed at which to move the rotating blade 122 (which rotates at a much faster rotational speed) into the product P to slice the product P. More specifically, the speed of rotation of the blade 122 is preferably set to rotate at approximately 1400 revolutions per minute (rpms) (or a surface speed of 6,780 feet per minute) while the blade 122 is also eccentrically rotated toward the product P at approximately 90 rpms. Thus, the rotational speed of the blade 122 (approximately 2600 rpms) and cutter rate of the blade 122 (90 rpms) toward and away from the product P is optimized to significantly reduce Kerf Loss and bone dust. The rotation of the blade 122 about the blade shaft 125 can be driven by a standard AC motor, or a servo motor. With the cutter speed being set at approximately 90 rpms and the blade rotational speed being set to approximately 1400 rpms, it has been determined that the slicing of the product P results in little to no pitting or roughing up of the sliced surfaces of the product P. In other words, at these determined cutter and rotational speeds, the sliced surfaces of the product P result in an end product with smooth surfaces, with little to no Kerf Loss or bone dust. The blade 122 is preferably 18.5 inches in diameter, with approximately 1008 teeth. With the above parameters, a cutter chip load of the product P results in approximately 0.0036 (+/−0.001) inches of engagement.

Referring to FIG. 10, additionally provided is at least one spiked or toothed follower plate 128. This follower plate 128 is configured to hold the product P in place while the product P is being sliced.

Within the lower portion of the cabinet 102 directly above and below the plate 120 and the blade 122 can be disposed sets of spray nozzles (not illustrated), which spray water directly on the area of the product P being sliced. Spray nozzles can be provided above and below the thickness table 120 and blade 122 to spray both sides thereof, thus providing a lubrication of the meat for a better cut. The spray nozzles also provide the benefit of washing away all bone dust being created by the blade 122 slicing through the bone portion of the product P. The spray nozzles contribute to the individual slices of the product P having smooth surfaces with little to no bone dust.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A meat slicing system to slice bone-in meat products, the system comprising:
a frame;
an elongated hollow chute connected to and extending upward from the frame to receive meat products therein, the chute including a follower configured to slide along an internal portion of the hollow chute by force of gravity to apply a force against the meat products therein to slide the meat product along the hollow chute;
an upper meat product support extending perpendicular to the chute, the upper meat product support including a first roller system extending therefrom and at least one pressure operated arm configured to apply pressure to the upper meat product support and the first roller system to press the first roller system against the meat product disposed within the chute to prevent the meat product from rotating as the meat product slides along the chute;
a lower meat product support disposed directly below the upper meat product support, the lower meat product support extending perpendicular to the chute and including a second roller system extending therefrom and at least one pressure operated arm configured to apply pressure to the lower meat product support and the second roller system to press the second roller system against the meat product disposed within the chute to prevent the meat product from rotating as the meat product slides along the chute;
a circular plate including a solid section and a cutout section, the circular plate including a first rotational shaft extending through a center thereof to rotate the circular plate such that the circular plate receives the meat product thereon and stops the meat product from sliding through the chute when the solid section thereof is rotated to a position adjacent to the chute; and
a transmission housing configured to rotate about the first rotating shaft and including a second rotational shaft that extends therefrom and is adjacent to the first rotational shaft of the circular plate, the second rotational shaft being connected to a center of a circular blade such that the circular blade is disposed between the chute and the circular plate, the circular blade being configured to rotate about a first rotation axis with the second rotational shaft and to rotate about a second rotation axis together with the first rotational shaft and the transmission housing such that the circular blade rotates towards meat product to slice off a predetermined thickness of the meat product when the solid section of the circular plate is in contact with the meat product.

2. The meat slicing system according to claim 1, wherein:
the first roller system is connected to the upper meat product support by a first hinge connector such that the first roller system pivots to accommodate meat products with different shapes; and
the second roller system is connected to the upper meat product support by a second hinge connector such that the second roller system pivots to accommodate meat products with different shapes.

3. The meat slicing system according to claim 2, wherein:
the first roller system includes a roller shaft with at least two rollers rotatably disposed thereon to roll along the meat product when the meat product slides along the hollow chute; and
the second roller system includes a roller shaft with at least two rollers rotatably disposed thereon to roll along the meat product when the meat product slides along the hollow chute.

4. The meat slicing system according to claim 3, wherein:
the at least one pressure operated arm of the upper meat product support includes a first pair of pressure operated arms, each first pressure operated arm being movable with respect to the upper meat product support; and
the at least one pressure operated arm of the lower meat product support includes a pair of pressure operated arms, each pressure operated arm being movable with respect to the lower meat product support.

5. The meat slicing system according to claim 4, further comprising:
a first support table connected to the hollow chute and including a pair of first support table posts connected thereto, each one of the pair of first pressure operated arms extending through a respective one of the first support table posts; and
a second support table connected to the hollow chute below the first support table and including a pair of second support table posts connected thereto, each one of the pair of second pressure operated arms extending through a respective one of the second support table posts.

6. The meat slicing system according to claim 4, wherein the pair of pressure operated arms of the upper and lower meat product supports are pneumatic pressure operated arms.

7. The meat slicing system according to claim 1, further comprising:
at least one follower rod extending along an outer side of the hollow chute and in parallel with the hollow chute, the at least one follower rod being engaged with an outer side of the follower to enable the follower to slide along the follower rod and along the internal portion of the hollow chute.

8. The meat slicing system according to claim 6, wherein the at least one follower rod includes a first follower rod disposed along a first side of the hollow chute and a second follower rod disposed at a second side of the hollow chute opposite the first side, both follower rods being engaged with the follower to enable the follower to slide along the first and second follower rods and along the internal portion of the hollow chute.

9. The meat slicing system according to claim 1, further comprising:
a first drive rotational system connected to the frame and configured to rotate the first rotational shaft.

10. The meat slicing system according to claim 1, further comprising:
a lift motor attached to the first rotational shaft to raise and lower a height of the circular plate such that different thicknesses of slices of meat product can be sliced off from the meat product extending out of the chute.

11. The meat slicing system according to claim 3, wherein the first roller system and the second roller system each include four rollers adjacent to each other to roll along the meat product as the meat product slides through the chute.

12. A meat slicing system to slice bone-in meat products, the system comprising:
a frame with a surface thereon, the surface including a hole therethrough;
an elongated hollow chute connected to and extending upward from the hole in the surface of the frame to receive meat products therein and feed the meat products through the hole;
a pair of follower rods extending in parallel along opposite sides so the chute, the pair of follower rods including a follower slidably attached to each of the pair of follower rods and configured to slide along the inner portion of the chute to force meat products to slide within the chute and through the hole in the surface of the frame;
a first support table surrounding the chute such that the chute extends therethrough, the first support table including a pair of first support table posts connected thereto, each of the pair of first support table posts including a respective one of a pair of first pressure operated arms movably extending therethrough;
a first roller system connected to the first pair of pressure operated arms to apply pressure to the meat product disposed within the chute to prevent rotation of the meat product while sliding through the chute;
a second support table surrounding the chute and disposed directly below the first support table such that the chute extends therethrough, the second support table including a pair of second support table posts connected thereto, each of the pair of second support table posts including a respective one of a pair of second pressure operated arms movably extending therethrough;
a second roller system connected to the second pair of pressure operated arms to apply pressure to the meat product disposed within the chute to prevent rotation of the meat product while sliding through the chute;
a first rotational drive system connected to the frame below the surface thereof and including a first rotational shaft extending therefrom;
a circular plate including a solid portion and a cutout portion, the circular plate being connected at a center thereof to the first rotational shaft to rotate the circular plate;
a transmission housing connected to the first rotational shaft to rotate with the first rotational shaft and including a second rotational shaft extending from a center thereof and disposed adjacent to the first rotational shaft; and
a circular blade connect to the second rotational shaft at a center portion thereof and disposed between the chute and the circular plate, the circular blade being configured to rotate about a second rotation axis with the second rotational shaft and to rotate about a first rotation axis with the first rotational shaft and the transmission housing such that the circular blade rotates towards meat product extending out of the chute to slice off a predetermined thickness of the meat product when the solid section of the circular plate is in contact with the meat product.

13. The meat slicing system according to claim 12, further comprising:
a lift motor attached to the first rotational shaft to raise and lower a height of the circular plate such that different thicknesses of slices of meat product can be sliced from the meat product extending out of the chute.

14. A meat product feeding system to feed meat products to a meat slicer, the system comprising:
a frame including a surface with an opening therethrough;
an elongated hollow chute connected to and extending upward from the surface of the frame above the opening to receive meat products therein;
a follower configured to slide along the inside of the chute to slide the meat products through the chute;
a first support table connected to and surrounding the chute and above the frame surface, the first support table including a pair of first support table posts connected thereto;
a first roller system connected to a first pair of pressure operated arms to apply pressure to the meat product disposed within the chute, the first pair of pressure operated arms extending through the first pair of support table posts and configured to extend therethrough to move the first roller system against the meat products to prevent the meat products from rotating within the chute while the meat products are slid through the chute;
a second support table connected to and surrounding the chute and disposed below the first support table, the second support table including a pair of second support table posts connected thereto; and
a second roller system connected to the second pair of pressure operated arms to apply pressure to the meat product disposed within the chute, the second pair of pressure operated arms extending through the pair of second support table posts and configured to extend therethrough to move the second roller system against the meat products to prevent the meat products from rotating within the chute while the meat products are slid through the chute.

15. The meat product feeding system according to claim 14, further comprising:
a pair of follower rods extending in parallel along opposite sides of the chute, the pair of follower rods being slidingly connected to the follower to guide the follower to slide along the inside of the chute to slide the meat products through the chute.
